(19) United States
(12) Patent Application Publication
(10) Pub. No.: US 2017/0259407 A1
(43) Pub. Date: Sep. 14, 2017

(54) Open-end wrench with dual wrenching modes

(71) Applicant: Richard J. Macor, Hunterdon County, NJ (US)

(72) Inventor: Richard J. Macor, Hunterdon County, NJ (US)

(21) Appl. No.: 14/998,940

(22) Filed: Mar. 8, 2016

(51) Int. Cl. B25B 13/46; B25B 13/08

(52) U.S. Cl. CPC B25B 13/46; B25B 13/08

(57) ABSTRACT

A wrench with an open-end wrench head that has at least two jaws. Each jaw has at least one internal engaging surface for engaging with a work-piece such as a nut or bolt that has an axis of rotation. Each of the at least one internal engaging surface of each jaw extends in a direction that creates an imaginary line when the wrench is viewed from a side view thereof. The wrench also has a handle extending from the wrench head and elongated in a predetermined direction defining at least one central axis of the handle. And, the wrench also has a ratcheting means that provides ratcheting capability to the wrench head when the handle is twisted back and forth by a user.

### FIELD OF THE INVENTION

The present invention relates to hand operated wrenches. More specifically, the present invention relates to wrenches that have an open-ended wrench head including adjustable wrenches that may be adjusted to fit a variety of different size work-pieces such as nuts and bolts.

### BACKGROUND OF THE INVENTION

Open-end wrenches including adjustable wrenches have been popular with users for decades. An advantage of the adjustable wrench is that the single wrench can be adjusted to fit a variety of different size work-pieces such as nuts and bolts. A disadvantage of the adjustable wrench is that the wrench must be removed between turning actions which is inefficient and time consuming. There have been some improvements to adjustable wrenches including the addition of various ratcheting mechanisms and jaw configurations. Traditional open-end, ratcheting wrenches have a ratcheting mechanism with a rotational axis that is generally perpendicular to the direction at which the jaw engaging surfaces are elongated, and, the direction at which the handle is elongated. This is the opposite of the present invention. Applicant contemplates an open wrench that has a second wrenching mode whereby a user may “run” a work-piece without removing the wrench from the work-piece, in a configuration that is structurally and functionally distinct from the prior art open-end wrenches.

### SUMMARY OF THE INVENTION

A wrench with an open-end wrench head and at least two jaws. Each jaw has at least one internal engaging surface for engaging with a work-piece such as a nut or bolt that has an axis of rotation. Each of the at least one internal engaging surface of each jaw extends in a direction that creates an imaginary line when the wrench is viewed from a side view thereof. The wrench also has a handle extending from the wrench head and elongated in a predetermined direction defining at least one central axis of the handle. And, the wrench also has a ratcheting means that provides ratcheting capability between the wrench head and the handle. The ratcheting means has an axis of rotation that is substantially parallel to the imaginary line created by the at least one internal engaging surface of at least one jaw, and, substantially aligned with the at least one central axis of the handle.

It is an objective that the present invention described herein provides a user with the novel benefit of a second wrenching mode, whereby, a user may “run” a work-piece with a ratcheting means when high torque is not required.

It is another objective that the present invention described herein provides a ratcheting means for use in the second wrenching mode to increase speed and reduce user labor.

It is another objective that the present invention described herein provides improved accessibility in tight work spaces.

And, it is another objective that the present invention described herein is commercially viable, simple in design, and cost-efficient to manufacture.

### BRIEF DESCRIPTION OF THE DRAWINGS

The present invention is more fully understood when the specification herein is taken in conjunction with the drawings appended hereto, wherein:

FIG. 1 shows a left side, elevation view of an example embodiment of an adjustable wrench engaging with a hexagonal nut while used in a first wrenching mode;

FIG. 2 shows the same adjustable wrench shown in FIG. 1 engaging with the same hexagonal nut while used in a second wrenching mode;

FIG. 3 shows a left side, elevation view of another example embodiment of an adjustable wrench engaging with a hexagonal nut while used in a first wrenching mode;

FIG. 4 shows the same adjustable wrench shown in FIG. 3 engaging with the same hexagonal nut while used in a second wrenching mode;

FIG. 5 shows a left side, elevation view of an example embodiment of an open-end wrench engaging with a hexagonal nut while used in a first wrenching mode;

FIG. 6 shows the same wrench shown in FIG. 5 engaging with the same hexagonal nut while used in a second wrenching mode;

FIG. 7 shows a cut, front perspective elevation view of an example embodiment of an open-end wrench;

FIG. 8 shows a front, elevation view of the open-end wrench shown in FIG. 8 engaging with a hexagonal nut.

### DETAILED DESCRIPTION OF THE DRAWINGS

The various drawings provided herein are for the purpose of illustrating examples of the present invention and not for the purpose of limiting same. Therefore, the drawings herein represent only a few of the many possible examples, embodiments, variations and/or applications of the present invention.

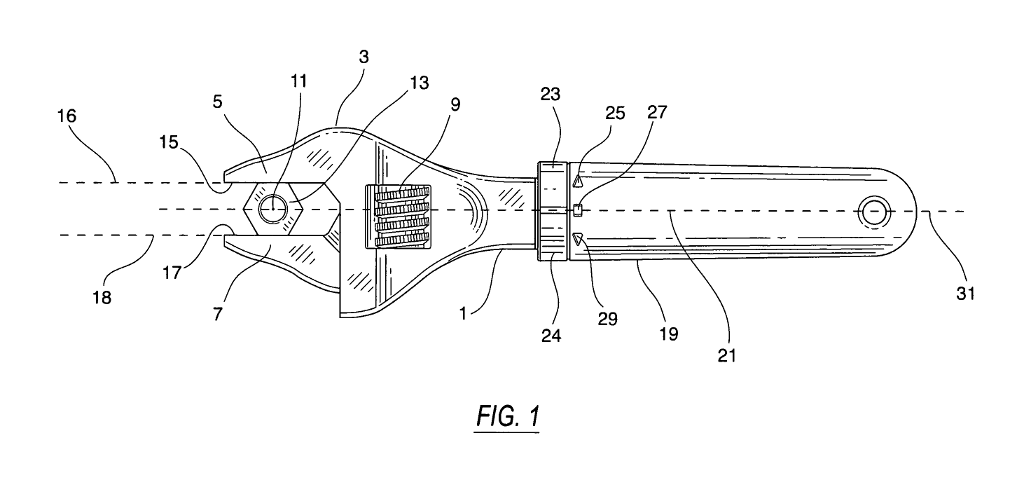

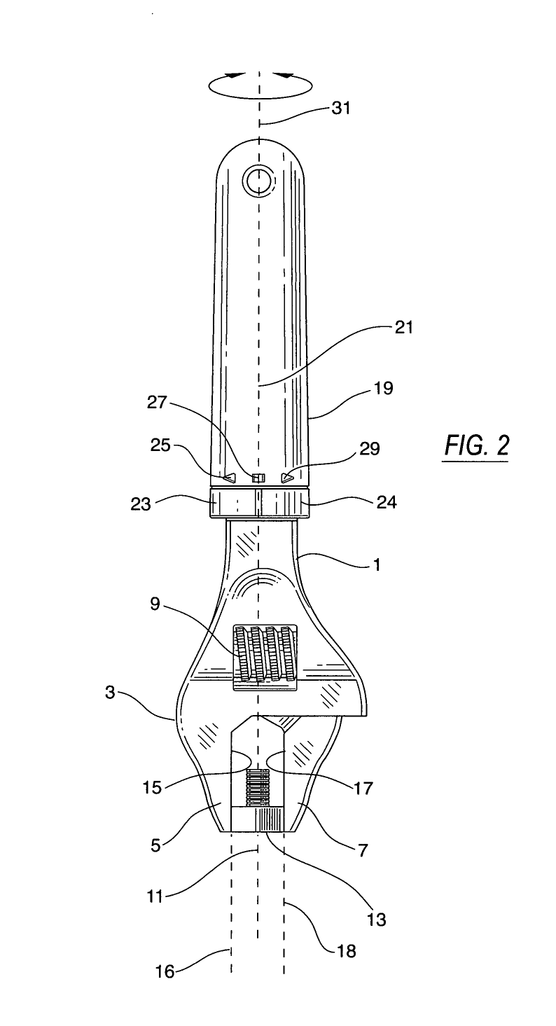

Referring now to FIGS. 1 and 2 together, FIG. 1 shows a left side, elevation view of an example embodiment of an adjustable wrench engaging with a hexagonal nut while used in a first wrenching mode; and, FIG. 2 shows the same adjustable wrench shown in FIG. 1 engaging with the same hexagonal nut while used in a second wrenching mode. Adjustable wrench 1 has an open-end wrench head 3 with two jaws 5 and 7, and an adjustment means 9. Adjusting means 9 may be turned to adjust space between jaws 5 and 7. The adjustable wrench versions of the present invention are formed so that at least one jaw is movable relative to the other jaw via an adjustment means. In this embodiment of the present invention, jaw 5 is fixed and jaw 7 is movable via adjustment means 9. However, the present invention adjustable wrench could also be configured with two moving jaws that move separately or simultaneously via an adjustment means or mechanism. Each jaw 5 and 7 has at least one internal engaging surface for engaging with a work-piece such as a nut, bolt, fastener, etc. Jaw 5 has an internal engaging surface 15; and, jaw 7 has an internal engaging surface 17. In this case, each jaw 5 and 7 has only one internal engaging surface for engaging with a work-piece, however, the present invention wrenches may have one jaw or both jaws with multiple engaging surfaces. Each internal engaging surface 15 and 17 creates an imaginary line when the wrench is viewed from a side view thereof. As seen in this left side view, engaging surface 15 of jaw 5 creates imaginary line 16; and, engaging surface 17 of jaw 7 creates imaginary line 18.

Shown in FIG. 1, engaging surfaces 15 and 17 of jaws 5 and 7 respectively, are engaged with a work-piece 13 (a hexagonal nut) wherein wrench 1 is pulled or pushed to turn work-piece 13 about axis of rotation 11. Wrench 1 is then disengaged, reoriented, and re-engaged to turn work-piece 13. This is a typical, first mode of usage for the present invention wrench 1 which is similar to traditional wrenches. Wrench 1 also has a handle 19 extending from wrench head 3 and is elongated in a predetermined direction which defines central axis 21. The present invention may have a handle with one or more sections elongated in one or more different predetermined directions defining one or more handle central axes. In this case, handle 19 extends from wrench head 3 and is elongated in only one predetermined direction defining only one central axis 21.

Wrench 1 also has a ratcheting means 23 providing ratcheting capability between wrench head 3 and handle 19 when handle 19 is twisted clockwise or counter-clockwise. When referring to a “ratcheting means” applicant defines such means as any mean(s) or mechanism(s) including but not limited to gear(s) pawl(s) clutch(s) etc. that allow(s) for free rotation of a tool component in one direction while preventing free rotation of the tool component in the other direction. A heavy duty version of the ratcheting mechanism using gear(s) and pawl(s) commonly found in ratcheting screwdrivers is contemplated. The ratcheting means or mechanism(s) could be positioned anywhere on the wrench tool, however, it's preferable that the ratcheting means is positioned somewhere along the handle or between the handle and wrench head. The ratcheting means 23 has an axis of rotation 31 that is substantially parallel to the imaginary line created by at least one engaging surface of at least one wrench jaw of the wrench. In this case, the axis of rotation 31 of ratcheting means 23 is parallel to both the imaginary lines 16 and 18 of engaging surfaces 15 and 17 respectively.

As seen in FIG. 2, when wrench 1 is oriented for use in a second wrenching mode, a user can “run” a work-piece clockwise or counter-clockwise without the need to remove, re-orientate and re-engage the wrench with the work-piece by simply twisting handle 19 back and forth about the axis of rotation 31 of ratcheting means 23. To provide yet more versatility, ratcheting means 23 has a collar 24 which may be rotated into three different positions to control the direction of the ratcheting means, whereby, when collar 24 of ratcheting means 23 is rotated to align with marker 25, ratcheting means 23 is activated for clockwise rotation to run a work-piece during installation; and, if collar 24 of ratcheting means 23 is rotated to align with marker 29, ratcheting means 23 is activated for counter-clockwise rotation to run a work-piece during removal. And, if collar 24 of ratcheting means 23 is in the center position 27 (as shown), wrench head 3 and handle 19 are locked together and the ratcheting means is selectively deactivated.

As shown in FIGS. 1 and 2, to eliminate a wobble effect rotational axis 31 of ratcheting means 23 is substantially aligned with the center axis 21 of handle 19 to facilitate the second wrenching mode of wrench 1 to “run” a work-piece such as a nut or bolt, etc. more efficiently and quickly.

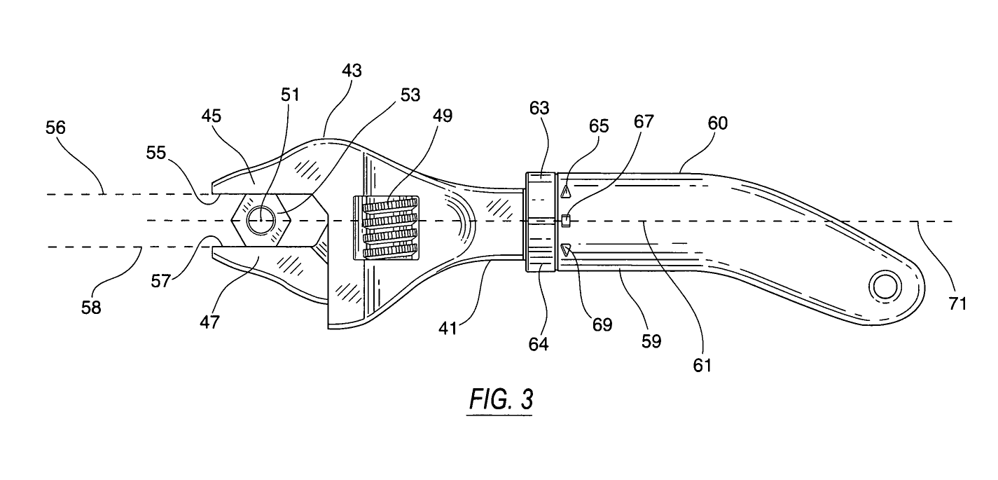

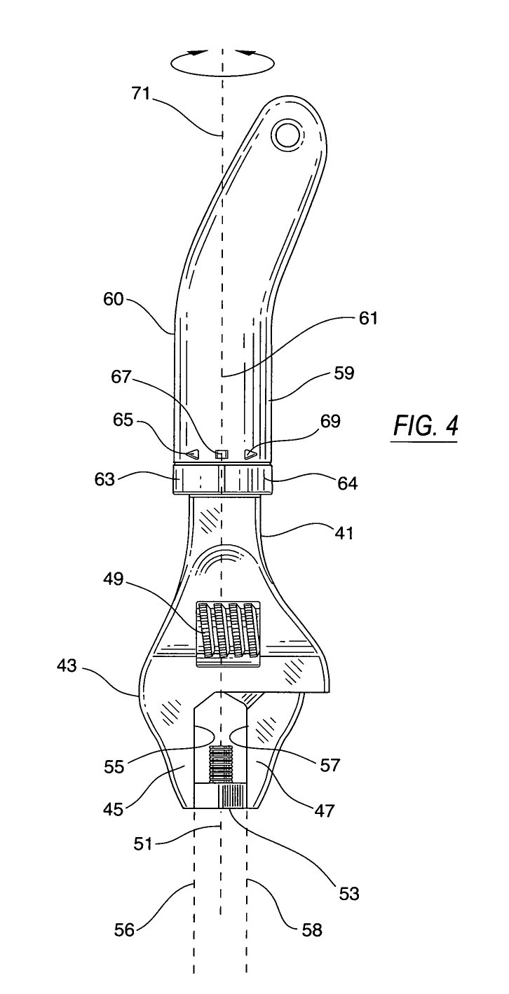

Referring now to FIGS. 3 and 4 together, FIG. 3 shows a left side, elevation view of an example embodiment of an adjustable wrench engaging with a hexagonal nut while used in a first wrenching mode; and, FIG. 4 shows the same adjustable wrench shown in FIG. 3 engaging with the same hexagonal nut while used in a second wrenching mode. Adjustable wrench 41 has an open-end wrench head 43 with two jaws 45 and 47, and an adjustment means 49. Adjusting means 49 may be turned to adjust space between jaws 45 and 47. The adjustable wrench versions of the present invention are formed so that at least one jaw is movable relative to the other jaw via an adjustment means. In this embodiment of the present invention jaw 45 is fixed and jaw 47 is movable via adjustment means 49. However, the present invention adjustable wrench could also be configured with two moving jaws that move separately or simultaneously via an adjustment means or mechanism. Each jaw 45 and 47 has at least one internal engaging surface for engaging with a work-piece such as a nut, bolt, fastener, etc. Jaw 45 has an internal engaging surface 55; and, jaw 47 has an internal engaging surface 57. In this case, each jaw 45 and 47 has only one internal engaging surface for engaging with a work-piece, however, the present invention wrenches may have one jaw or both jaws with multiple engaging surfaces. Each internal engaging surface 55 and 57 creates an imaginary line when the wrench is viewed from a side view thereof. As seen in this left side view, engaging surface 55 of jaw 45 creates imaginary line 56; and, engaging surface 57 of jaw 47 creates imaginary line 58.

Shown in FIG. 3, engaging surfaces 55 and 57 of jaws 45 and 47 respectively, are engaged with a work-piece 53 (a hexagonal nut) wherein wrench 41 is pulled or pushed to turn work-piece 53 about axis of rotation 51. Wrench 41 is then disengaged, reoriented, and re-engaged to turn work-piece 53. This is a typical, first mode of usage for the present invention wrench 41 which is similar to traditional wrenches. Wrench 41 also has a handle 59 extending from wrench head 43 and is elongated in a predetermined direction which defines central axis 61. The present invention may have a handle with one or more sections elongated in one or more different predetermined directions defining one or more handle central axes. In this embodiment, handle 59 has an elongated section 60 extending from the wrench head 43 which is elongated in a predetermined direction defining central axis 61 of handle 59. Wrench 41 also has a ratcheting means 63 providing ratcheting capability between wrench head 43 and handle 59 when handle 59 is twisted clockwise or counter-clockwise. When referring to a “ratcheting means” applicant defines such means as any mean(s) or mechanism(s) including but not limited to gear(s) pawl(s) clutch(s) etc. that allow(s) for free rotation of a tool component in one direction while preventing free rotation of the tool component in the other direction. A heavy duty version of the ratcheting mechanism using gear(s) and pawl(s) commonly found in ratcheting screwdrivers is contemplated. The ratcheting means or mechanism(s) could be positioned anywhere on the wrench tool, however, it's preferable that the ratcheting means is positioned somewhere along the handle or between the handle and wrench head. The ratcheting means 63 has an axis of rotation 71 that is substantially parallel to the imaginary line created by at least one engaging surface of at least one wrench jaw of the wrench. In this case, the axis of rotation 71 of ratcheting means 63 is parallel to both the imaginary lines 56 and 58 of engaging surfaces 55 and 57 respectively.

As seen in FIG. 4, when wrench 41 is oriented for use in a second wrenching mode, a user can “run” a work-piece clockwise or counter-clockwise without the need to remove, re-orientate and re-engage the wrench with the work-piece by simply twisting handle 59 back and forth about the axis of rotation 71 of ratcheting means 63. To provide yet more versatility, ratcheting means 63 has a collar 64 which may be rotated into three different positions to control the direction of the ratcheting means, whereby, when collar 64 of ratcheting means 63 is rotated to align with marker 65, ratcheting means 63 is activated for clockwise rotation to run a work-piece during installation; and, if collar 64 of ratcheting means 63 is rotated to align with marker 69, ratcheting means 63 is activated for counter-clockwise rotation to run a work-piece during removal. And, if collar 64 of ratcheting means 63 is in the center position 67 (as shown), wrench head 43 and handle 59 are locked together and the ratcheting means is selectively deactivated.

As shown in FIGS. 3 and 4, to eliminate a wobble effect rotational axis 71 of ratcheting means 63 is substantially aligned with the center axis 61 of handle 59 to facilitate the second wrenching mode of wrench 41 to “run” a work-piece such as a nut or bolt, etc. more efficiently and quickly.

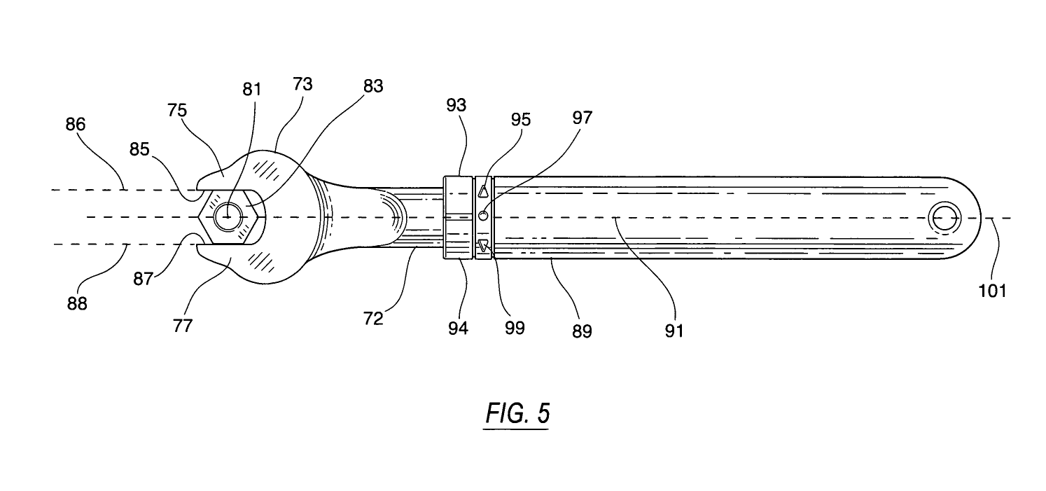

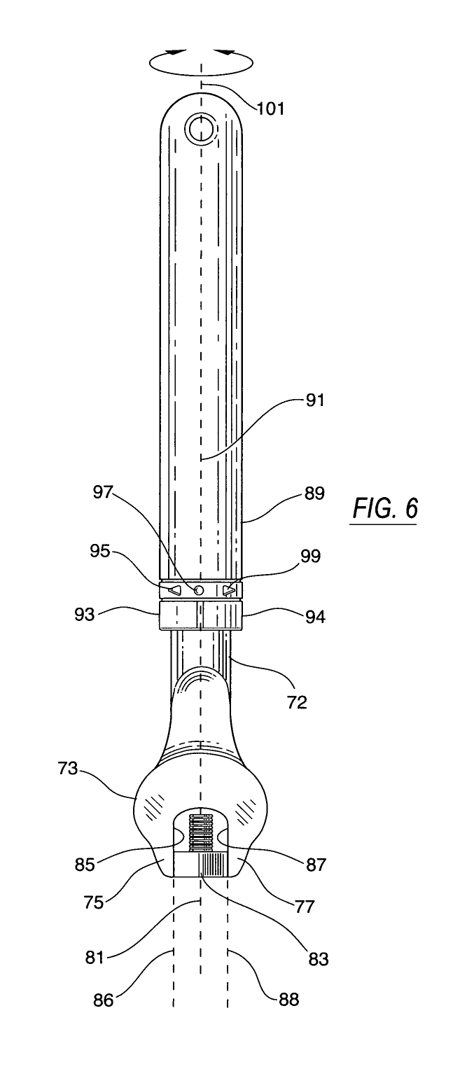

Referring now to FIGS. 5 and 6 together, FIG. 5 shows a left side, elevation view of an example embodiment of an open-end wrench engaging with a hexagonal nut while used in a first wrenching mode; and, FIG. 6 shows the same open-end wrench shown in FIG. 5 engaging with the same hexagonal nut while used in a second wrenching mode. Open-end wrench 72 has an open-end wrench head 73 with two jaws 75 and 77. Each jaw 75 and 77 has at least one internal engaging surface for engaging with a work-piece such as a nut, bolt, fastener, etc. Jaw 75 has an internal engaging surface 85; and, jaw 77 has an internal engaging surface 87. In this case, each jaw 75 and 77 has only one internal engaging surface for engaging with a work-piece, however, the present invention wrenches may have one jaw or both jaws with multiple engaging surfaces. Each internal engaging surface 85 and 87 creates an imaginary line when the wrench is viewed from a side view thereof. As seen in this left side view, engaging surface 85 of jaw 75 creates imaginary line 86; and, engaging surface 87 of jaw 77 creates imaginary line 88.

Shown in FIG. 5, engaging surfaces 85 and 87 of jaws 75 and 77 respectively, are engaged with a work-piece 83 (a hexagonal nut) wherein wrench 72 is pulled or pushed to turn work-piece 83 about axis of rotation 81. Wrench 72 is then disengaged, reoriented, and re-engaged to turn work-piece 83. This is a typical, first mode of usage for the present invention wrench 72 which is similar to traditional wrenches. Wrench 72 also has a handle 89 extending from wrench head 73 and is elongated in a predetermined direction which defines central axis 91. The present invention may have a handle with one or more sections elongated in one or more different predetermined directions defining one or more handle central axes. In this case, handle 89 extends from wrench head 73 and is elongated in only one predetermined direction defining only one central axis 91. Wrench 72 also has a ratcheting means 93 providing ratcheting capability between wrench head 73 and handle 89 when handle 89 is twisted clockwise or counter-clockwise. When referring to a “ratcheting means” applicant defines such means as any mean(s) or mechanism(s) including but not limited to gear(s) pawl(s) clutch(s) etc. that allow(s) for free rotation of a tool component in one direction while preventing free rotation of the tool component in the other direction. A heavy duty version of the ratcheting mechanism using gear(s) and pawl(s) commonly found in ratcheting screwdrivers is contemplated. The ratcheting means or mechanism(s) could be positioned anywhere on the wrench tool, however, it's preferable that the ratcheting means is positioned somewhere along the handle or between the handle and wrench head. The ratcheting means 93 has an axis of rotation 101 that is substantially parallel to the imaginary line created by at least one engaging surface of at least one wrench jaw of the wrench. In this case, the axis of rotation 101 of ratcheting means 93 is parallel to both the imaginary lines 86 and 88 of engaging surfaces 85 and 87 respectively.

As seen in FIG. 6, when wrench 72 is oriented for use in a second wrenching mode, a user can “run” a work-piece clockwise or counter-clockwise without the need to remove, re-orientate and re-engage the wrench with the work-piece by simply twisting handle 89 back and forth about the axis of rotation 101 of ratcheting means 93. To provide yet more versatility, ratcheting means 93 has a collar 94 which may be rotated into three different positions to control the direction of the ratcheting means, whereby, when collar 94 of ratcheting means 93 is rotated to align with marker 95, ratcheting means 93 is activated for clockwise rotation to run a work-piece during installation; and, if collar 94 of ratcheting means 93 is rotated to align with marker 99, ratcheting means 93 is activated for counter-clockwise rotation to run a work-piece during removal. And, if collar 94 of ratcheting means 93 is in the center position 97 (as shown), wrench head 73 and handle 89 are locked together and the ratcheting means is selectively deactivated.

As shown in FIGS. 5 and 6, to eliminate a wobble effect rotational axis 101 of ratcheting means 93 is substantially aligned with the center axis 91 of handle 89 extending from wrench head 73 to facilitate the second wrenching mode of wrench 72 to “run” a work-piece such as a nut or bolt, etc. more efficiently and quickly.

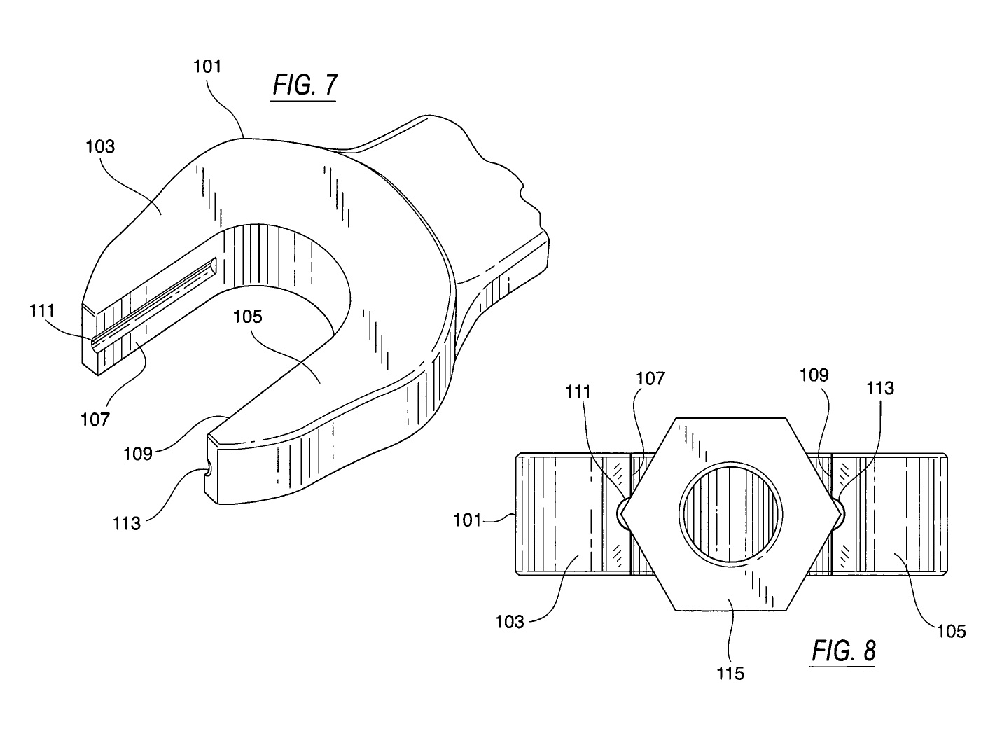

Referring now to FIGS. 7 and 8 together, FIG. 7 shows a cut, front perspective elevation view of an example embodiment of an open-end wrench; and, FIG. 8 shows a front, elevation view of the open-end wrench shown in FIG. 7 engaging with a hexagonal nut. Wrench head 101 has jaws 103 and 105. Jaws 103 and 105 have respective engaging surfaces 107 and 109. Each jaw 103 and 105 is elongated (longer than it is wide.) To enhance engagement between a work-piece and a wrench such as wrench 101 and work-piece 115 shown in FIG. 8, each of engaging surfaces 107 and 109 of jaws 103 and 105 respectively have a groove running to the distal end thereof. Engaging surface 107 of jaw 103 has groove 111 running to the distal end thereof; and, engaging surface 109 of jaw 105 has groove 113 running to the distal end thereof. As seen best in FIG. 8, the grooves help to control engagement with a work-piece when the wrench is used in the secondary wrenching mode also defined in FIGS. 2, 4, and 6 herein. If a user chose to engage the “flats” of a work-piece (instead of the “points”) with a present invention wrench, it would be advantageous to have least one engaging surface of each jaw (both jaws) roughened whereby the at least one engaging surface of each jaw is non-smooth. This could be achieved in many different ways including using a series if grooves or small ridges running in a lengthwise direction. Or, using a series of grooves or ridges formed in a cross pattern or other pattern. Or, using any form of a textured surface, etc., wherein at least one engaging surface of each jaw is non-smooth to increase the coefficient of friction between each engaging surface and the “flats” of a work-piece to prohibit the wrench jaws from slipping off the work-piece while the ratcheting means is utilized by a user in a second mode of use.

Upon reading and understanding the specification of the present invention described above, modifications and alterations will become apparent to those skilled in the art. It is intended that all such modifications and alterations be included insofar as they come within the scope of the patent as claimed or the equivalence thereof.

What is claimed is:

1. A wrench comprising:
an open-end wrench head having at least two jaws, each said jaw having at least one internal engaging surface for engaging with a work-piece such as a nut or bolt having an axis of rotation, each of said at least one internal engaging surface of each said jaw extending in a direction creating an imaginary line when said wrench is viewed from a side view thereof; and,
a handle extending from said wrench head and elongated in a predetermined direction defining at least one central axis of said handle; and,
a ratcheting means providing ratcheting capability to said wrench head when said handle is twisted back and forth by a user, said ratcheting means having an axis of rotation being substantially parallel to the imaginary line created by the at least one internal engaging surface of at least one said jaw, and, substantially aligned with the at least one central axis of said handle.

2. The open-end wrench according to claim 1, wherein, the axis of rotation of said ratcheting means is substantially parallel to the imaginary line created by the at least one internal engaging surface of each said jaw.

3. The open-end wrench according to claim 1, wherein the at least one central axis of said handle extending from said wrench head is substantially parallel to the imaginary line of the at least one engaging surface of at least one said jaw of said wrench head.

4. The open-end wrench according to claim 1, wherein the at least one central axis of said handle extending from said wrench head is substantially parallel to the imaginary line of the at least one engaging surface of each said jaw of said wrench head.

5. The open-end wrench according to claim 1, wherein the at least one engaging surface of each said jaw is non-smooth so as to increase the coefficient of friction between each said engaging surface and a work-piece to prohibit the wrench jaws from slipping off the work-piece while the ratcheting means is utilized by a user.

6. The open-end wrench according to claim 2, wherein the at least one central axis of said handle extending from said wrench head is substantially parallel to the imaginary line of the at least one engaging surface of at least one said jaw of said wrench head.

7. The open-end wrench according to claim 2, wherein the at least one central axis of said handle extending from said wrench head is substantially parallel to the imaginary line of the at least one engaging surface of each said jaw of said wrench head.

8. The open-end wrench according to claim 2, wherein the at least one engaging surface of each said jaw is non-smooth so as to increase the coefficient of friction between each said engaging surface and a work-piece to prohibit the wrench jaws from slipping off the work-piece while the ratcheting means is utilized by a user.

9. An adjustable wrench comprising:
an open-end wrench head having at least two jaws, at least one said jaw being movable, each said jaw having at least one internal engaging surface for engaging with a work-piece such as a nut or bolt having an axis of rotation, each of said at least one internal engaging surface of each said jaw extending in a direction creating an imaginary line when said wrench is viewed from a side view thereof; and,
an adjusting means by which space between the at least two jaws is adjustable; and,
a handle extending from said wrench head and elongated in a predetermined direction defining at least one central axis of said handle; and,
a ratcheting means providing ratcheting capability to said wrench head when said handle is twisted back and forth by a user, said ratcheting means having an axis of rotation being substantially parallel to the imaginary line created by the at least one internal engaging surface of at least one said jaw, and, substantially aligned with the at least one central axis of said handle.

10. The adjustable wrench according to claim 9, wherein, there are only two jaws.

11. The adjustable wrench according to claim 9, wherein, there are only two jaws and both said jaws are adjustably movable.

12. The adjustable wrench according to claim 9, wherein, the axis of rotation of said ratcheting means is substantially parallel to the imaginary line created by the at least one internal engaging surface of each said jaw.

13. The open-end wrench according to claim 9, wherein the at least one central axis of said handle extending from said wrench head is substantially parallel to the imaginary line of the at least one engaging surface of at least one said jaw of said wrench head.

14. The open-end wrench according to claim 9, wherein the at least one central axis of said handle extending from said wrench head is substantially parallel to the imaginary line of the at least one engaging surface of each said jaw of said wrench head.

15. The adjustable wrench according to claim 9, wherein the at least one engaging surface of each said jaw is non-smooth so as to increase the coefficient of friction between each said engaging surface and a work-piece to prohibit the wrench jaws from slipping off the work-piece while the ratcheting means is utilized by a user.

16. The adjustable wrench according to claim 10, wherein, there are only two jaws and both said jaws are adjustably movable.

17. The adjustable wrench according to claim 10, wherein, the axis of rotation of said ratcheting means is substantially parallel to the imaginary line created by the at least one internal engaging surface of each said jaw.

18. The open-end wrench according to claim 10, wherein the at least one central axis of said handle extending from said wrench head is substantially parallel to the imaginary line of the at least one engaging surface of at least one said jaw of said wrench head.

19. The open-end wrench according to claim 10, wherein the at least one central axis of said handle extending from said wrench head is substantially parallel to the imaginary line of the at least one engaging surface of each said jaw of said wrench head.

15. (canceled)

20. The adjustable wrench according to claim 10, wherein the at least one engaging surface of each said jaw is non-smooth so as to increase the coefficient of friction between each said engaging surface and a work-piece to prohibit the wrench jaws from slipping off the work-piece while the ratcheting means is utilized by a user.
